(19) United States
(12) Patent Application Publication
(10) Pub. No.: US 2022/0084135 A1
(43) Pub. Date: Mar. 17, 2022

(54) Accounts Confirmation System and Method

(71) Applicant: Crowe LLP, Oak Brook, IL (US)

(72) Inventor: Jason A. Whitmer, South Bend, IN (US)

(21) Appl. No.: 17/533,346

(22) Filed: Nov. 23, 2021

Related U.S. Application Data
(63) Continuation of application No. 15/785,907, filed on Oct. 17, 2017, now abandoned.
(60) Provisional application No. 62/411,118, filed on Oct. 21, 2016.

(51) Int. Cl. G06Q 40/00; G06F 21/50; H04L 9/32; G06Q 10/06; G06F 21/31

(52) U.S. Cl. CPC G06Q 40/125; G06F 21/50; G06F 21/31; G06Q 10/063114; H04L 9/321

(57) ABSTRACT

A computerized system for performing accounts confirmation of a financial institution's customers. The computerized system solves the security problem of electronically presenting financial information to the financial institution's customers for confirmation. In one embodiment, the system includes specialized software that makes calls using an application programming interface (“API”) of a third-party identification verification server, which allows the auditor to verify the identity of the financial institution's customers prior to providing financial information to be confirmed.

### RELATED APPLICATIONS

This is a continuation of application Ser. No. 15/785,907 filed Oct. 17, 2017, for an Accounts Confirmation System and Method, which claimed the benefit of U.S. Provisional Application Ser. No. 62/411,118 filed Oct. 21, 2016, for an Accounts Confirmation System and Method. Both of these applications are hereby incorporated by reference in their entireties.

### TECHNICAL FIELD

This disclosure relates generally to the technical problem of electronically confirming information in accounts of a financial institution with its customers; in particular, this disclosure relates to an electronic system with specialized software that interacts with a third-party identification verification server that validates the identity of a financial institution's customers, electronically presents information for the customer to confirm about their accounts, and tracks the confirmation process substantially in real-time for both an auditor and the financial institution.

### BACKGROUND AND SUMMARY

The accounts of financial institutions are periodically audited. During the audit, there is an accounts confirmation process in which the customers of the financial institution are contacted to confirm whether certain information about their account is correct. The auditor sends confirmation requests to the physical addresses of the financial institution's customers and processes the confirmation responses in return mail, which is a time intensive process. Moreover, the status of an ongoing confirmation process is not transparent to the financial institution, but must be manually communicated by the auditor in status reports.

While many processes can be automated through computers, there are technical challenges to doing so with the accounts confirmation process. Unlike paper confirmation requests that are mailed to the physical address of the financial institution's customers, these requests contain financial information about the customer's accounts and cannot simply be emailed to the customer due to security concerns. The auditor would typically only have an email address to electronically communicate with the financial institution's customer, and is therefore presented with a technical problem of how to electronically communicate the confirmation requests to the customer without potential security concerns of having a third party obtain access to the customer's financial information.

This disclosure relates to a computerized system for performing accounts confirmation of a financial institution's customers. The computerized system solves the security problem of electronically presenting financial information to the financial institution's customers for confirmation. In one embodiment, the system includes specialized software that makes calls using an application programming interface (“API”) of a third-party identification verification server, which allows the auditor to verify the identity of the financial institution's customers prior to providing financial information to be confirmed. In some embodiments, the system includes a substantially real-time status dashboard that allows the financial institution visibility to review the status of an ongoing confirmation process. Since this process is automated, the system creates an audit trail each step of the way to provide compliance-oriented monitoring over the data flow from the auditor's interactions with the financial institution and its customers.

### BRIEF DESCRIPTION OF THE DRAWINGS

The detailed description makes reference to the accompanying figures in which:

FIG. 1 is a diagrammatic view of an example computing device in which the accounts confirmation system could operate according to one embodiment;

FIG. 2 is a diagrammatic view of an example computing environment in which the accounts confirmation system could operate according to one embodiment;

FIG. 3 is a diagrammatic view of example modules of the accounts confirmation system according to one embodiment;

FIG. 4 is a flow chart showing example operations of the accounts confirmation system according to one embodiment;

FIG. 5 is a flow chart showing example data flow operations of the accounts confirmation system according to one embodiment;

FIGS. 6-20 are screenshots showing an example interface for use by an auditor according to an embodiment of the accounts confirmation system;

FIGS. 21-32 are screenshots showing an example interface for use by a financial institution according to an embodiment of the accounts confirmation system; and

FIGS. 33-36 are screenshots showing an example interface for use by the customer of a financial institution according to an embodiment of the accounts confirmation system.

### Detailed Description of the Drawings

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The detailed description which follows is presented in part in terms of algorithms and symbolic representations of operations on data bits within a computer memory representing alphanumeric characters or other information. An algorithm is provided by this disclosure and is generally conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. A method and apparatus are disclosed for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself, rather as a result of an instruction. The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An apparatus is disclosed for performing these operations. This apparatus may be specifically constructed for the required purposes, or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

In the following description several terms which are used frequently have specialized meanings in the present context. The term “network” means two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. The term “browser” refers to a program which is not necessarily apparent to the user, but which is responsible for transmitting messages between the user's computer and the network server and for displaying and interacting with network resources.

Browsers are designed to utilize a communications protocol for transmission of text and graphic information over a worldwide network of computers, namely the “World Wide Web” or simply the “Web.” Examples of browsers compatible with the present invention include the Internet Explorer browser program offered by Microsoft Corporation (Internet Explorer is a trademark of Microsoft Corporation), the Chrome browser program offered by Google Inc. (Chrome is a trademark of Google Inc.), the Safari browser program offered by Apple Inc. (Safari is a trademark of Apple Inc.) or the Firefox browser program distributed by the Mozilla Foundation (Firefox is a registered trademark of the Mozilla Foundation). The browser could operate on a desktop operating system, such as Windows by Microsoft Corporation (Windows is a trademark of Microsoft Corporation) or OS X by Apple Inc. (OS X is a trademark of Apple Inc.). In some cases, the browser could operate on mobile operating systems, such as iOS by Apple Inc. (iOS is a trademark of Apple Inc.) or Android by Google Inc. (Android is a trademark of Google Inc.). Browsers display information which is formatted in a Standard Generalized Markup Language (“SGML”) or a Hyper Text Markup Language (“HTML”), both being scripting languages which embed non-visual codes in a text document through the use of special ASCII text codes. Files in these formats may be easily transmitted across computer networks, including global information networks like the Internet, and allow the browsers to display text, images, and play audio and video recordings.

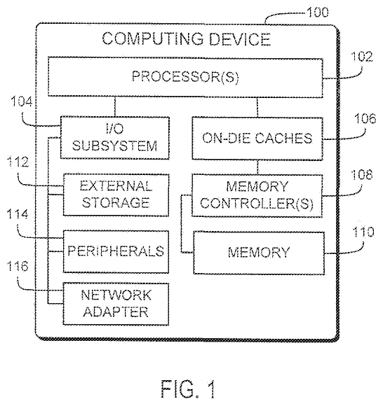

Referring now to FIG. 1, an illustrative computing device 100 for the accounts confirmation system, includes at least one processor 102, an I/O subsystem 104, at least one on-die cache 106, and a memory controller 108 to control a memory 110. The computing device 100 may be embodied as any type of device capable of performing the functions described herein. For example, the computing device 100 may be embodied as, without limitation, a computer, a workstation, a server computer, a laptop computer, a notebook computer, a tablet computer, a smartphone, a mobile computing device, a desktop computer, a distributed computing system, a multiprocessor system, a consumer electronic device, a smart appliance, and/or any other computing device capable of analyzing software code segments.

As shown in FIG. 1, the illustrative computing device 100 includes the processor 102, the I/O subsystem 104, the on-die cache 106, and the memory controller 108 to control a memory 110. Of course, the computing device 100 may include other or additional components, such as those commonly found in a workstation (e.g., various input/output devices), in other embodiments. For example, the computing device 100 may include an external storage 112, peripherals 114, and/or a network adapter 116. Additionally, in some embodiments, one or more of the illustrative components may be incorporated in, or otherwise form a portion of, another component. For example, the memory 110 or portions thereof, may be incorporated in the processor 102 in some embodiments.

The processor 102 may be embodied as any type of processor capable of performing the functions described herein. For example, the processor may be embodied as a single or multi-core processor(s), digital signal processor, microcontroller, or other processor or processing/controlling circuit. The memory 110 may be embodied as any type of volatile memory and/or persistent memory capable of performing the functions described herein. In operation, the memory 110 may store various data and software used during operation of the computing device 100 such as operating systems, applications, programs, libraries, and drivers. The memory 110 is communicatively coupled to the processor 102 via the memory bus using memory controller(s) 108, which may be embodied as circuitry and/or components to facilitate input/output operations with the processor 102, the memory 110, and other components of the computing device 100.

The I/O subsystem 104 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 104 may form a portion of a system-on-a-chip (SoC) and be incorporated, along with the processor 102, the memory 110, and other components of the computing device 100, on a single integrated circuit chip.

An external storage device 112 is coupled to the processor 102 with the I/O subsystem 104. The external storage device 112 may be embodied as any type of device or devices configured for short-term or long-term storage of data such as, for example, memory devices and circuits, memory cards, hard disk drives, solid-state drives, or other data storage devices.

The computing device 100 may include peripherals 114. The peripherals 114 may include any number of additional input/output devices, interface devices, and/or other peripheral devices. By way of example only, a peripheral may be a display that could be embodied as any type of display capable of displaying digital information such as a liquid crystal display (LCD), a light emitting diode (LED), a plasma display, a cathode ray tube (CRT), or other type of display device.

The computing device 100 illustratively includes a network adapter 116, which may be embodied as any communication circuit, device, or collection thereof, capable of enabling communications between the computing device 100 and other remote devices over a computer network (not shown). The network adapter 116 may be configured to use any one or more communication technology (e.g., wired or wireless communications) and associated protocols (e.g., Ethernet, Bluetooth®, Wi-Fi®, WiMAX, etc.) to effect such communication.

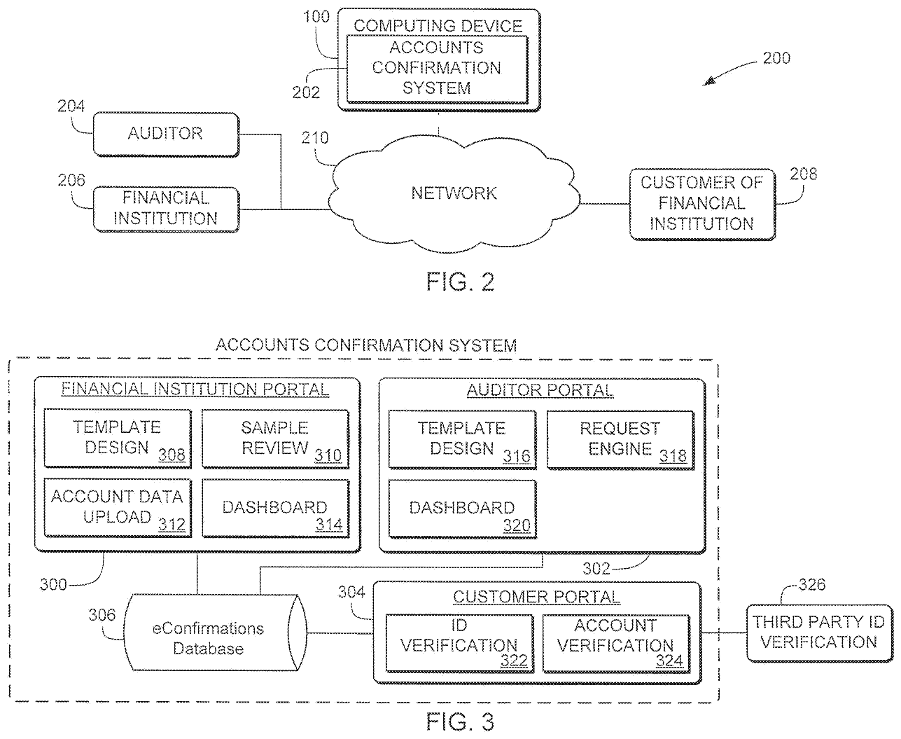

FIG. 2 is a high-level block diagram of a computing environment 200 under which the computing device 100 could operate the accounts confirmation system 202 according to one embodiment. FIG. 2 illustrates the computing device 100 with the accounts confirmation system 202, an auditor 204, a financial institution 206 and a customer of a financial institution 208 connected by a network 210. Although only a single auditor 204, a single financial institution 206, and a single customer the financial institution 208 are represented in FIG. 2 to simplify and clarify the description, a plurality of each are anticipated to operate with the accounts confirmation system 202. Likewise, a single computing device 100 on which the accounts confirmation system 202 operates is shown for purposes of simplicity, but multiple computing devices could be used to operate the accounts confirmation system 202. Embodiments of the computing environment 200 may have thousands or millions of auditors 204, financial institutions 206, and/or customers of financial institutions 208 connected to the network 210, for example, the Internet. Users (not shown) may operate software, such as a browser, on clients 204 to both send and receive messages over network 210 via computing device 100 and its associated communications equipment and software (not shown). For example, the accounts confirmation system 202 could be accessed via computing device 100 using a browser. Typically, clients 202 would be able to access the accounts confirmation system 202 over the network 204 by entering a web address, such as an IP address, URL, or domain name (web address generally referred to as a “Destination”) into browser software. In some embodiments, clients 202 could include a dedicated application that connects with the accounts confirmation system 202 instead of using a web browser.

FIG. 3 is a block diagram showing an embodiment with various modules that may be included in the accounts confirmation system 202. In the embodiment shown, the accounts confirmation system 202 includes a financial institution portal 300, an auditor portal 302, a customer portal 304, and an eConfirmation database 306. In the embodiment shown, the financial institution portal 300 includes a template design module 308, a sample review module 310, an account data upload module 312, and a dashboard module 314. As shown, the auditor portal 302 includes a template design module 316, a request engine 318, and a dashboard module 320. In the embodiment shown, the customer portal 304 includes an identification verification module 322 and an account verification module 324. As shown, the accounts confirmation system 202 is configured to communicate with a third-party identification verification server 326, such as via the network 210.

For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

The financial institution portal 300 is configured to allow a representative of a financial institution to perform certain tasks to coordinate with an auditor to confirm information regarding accounts. As shown, the financial institution portal 300 includes a template design module 308 that is configured to allow the representative to modify a template email to be sent to a customer to initiate the confirmation process, along potentially with other parameters of the accounts confirmation. For example, the templates to be modified could be provided, in some embodiments, by the auditor for modification by the financial institution. This allows the financial institution to tailor the communications with their customers. As shown, the financial institution portal 300 includes an account data upload module 312 that allows the representative to upload a universe of data for the accounts confirmation process. Upon uploading this data, the auditor, as explained below, can review this data from the auditor portal 302 to take a sample for purposes of auditing the accounts. In the embodiment shown, the financial institution portal 300 includes a sample review module which is configured to allow a representative to review the sample chosen by the auditor and determine whether the financial institution does not wish to communicate with certain customers selected in the sample. As shown, the financial institution portal 300 also includes a dashboard module 314 that allows the representative to review the status of certain parameters regarding the accounts confirmation process. For example, in some embodiments, the dashboard module 314 could provide a substantially real-time view of several parameters regarding the accounts confirmation process. These modules and their operation are described further below.

The auditor portal 302 is configured to allow an auditor to set up an audit of accounts of a financial institution. In the embodiment shown, the auditor portal 302 includes a template design module 316 that is configured to allow an auditor to design an accounts confirmation audit, including a template email for the financial institution, and parameters surrounding the timing of the audit and how it will be conducted. As shown, the auditor portal 302 includes a request engine 318 that is configured to allow communication with a representative of the financial institution to request information regarding accounts and other items concerning the accounts confirmation process. In the embodiment shown, the auditor portal 302 also includes a dashboard module 320 that is configured to show the auditor the status of various parameters in the accounts confirmation process. For example, the dashboard could show a substantially real-time view of the status concerning various parameters of the audit and allow the auditor to modify at least a portion of these parameters. These modules of the auditor portal 302 will be discussed with respect to their operation further below.

The customer portal 304 is configured to allow the identification of a customer of a financial institution to be verified so that their account can be confirmed. In the embodiment shown, the customer portal 304 includes an identification verification module 322 that is configured to communicate with a third-party identification verification server 326 to verify the customer's identification. For example, the third-party identification verification server 326 may include an application programming interface (“API”) that allows the identification verification module 322 to determine whether the customer's identification has been verified. For example, the third-party identification verification server 326 may ask the customer certain questions to verify the identity of the customer. As shown, the customer portal 304 also includes an account verification module 324 that is configured to allow the customer to confirm whether information regarding the account is correct. For example, the customer may be presented with information regarding its account and be asked to confirm or correct certain information, such as maturity date, interest rate, etc. According to one embodiment, the third-party identification verification server could be provided by IDology of Atlanta, Ga.

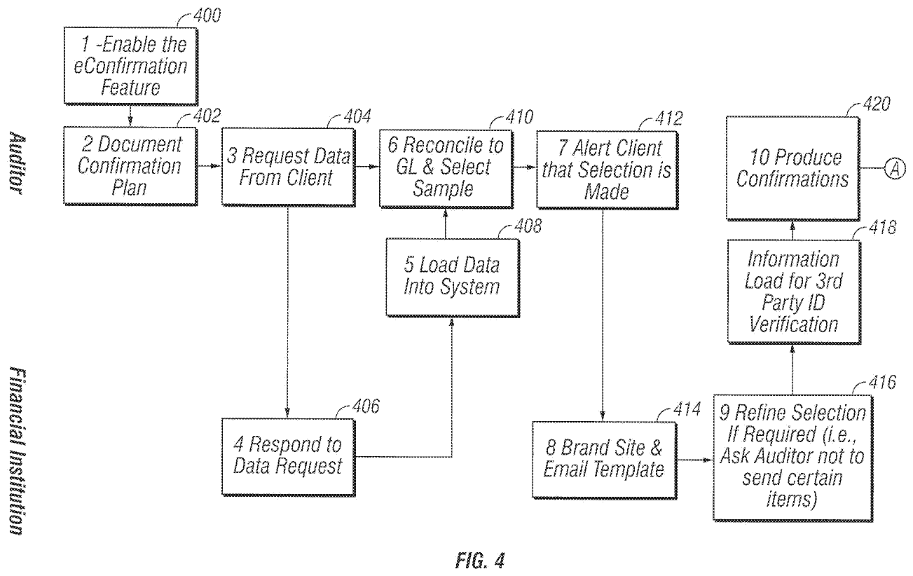

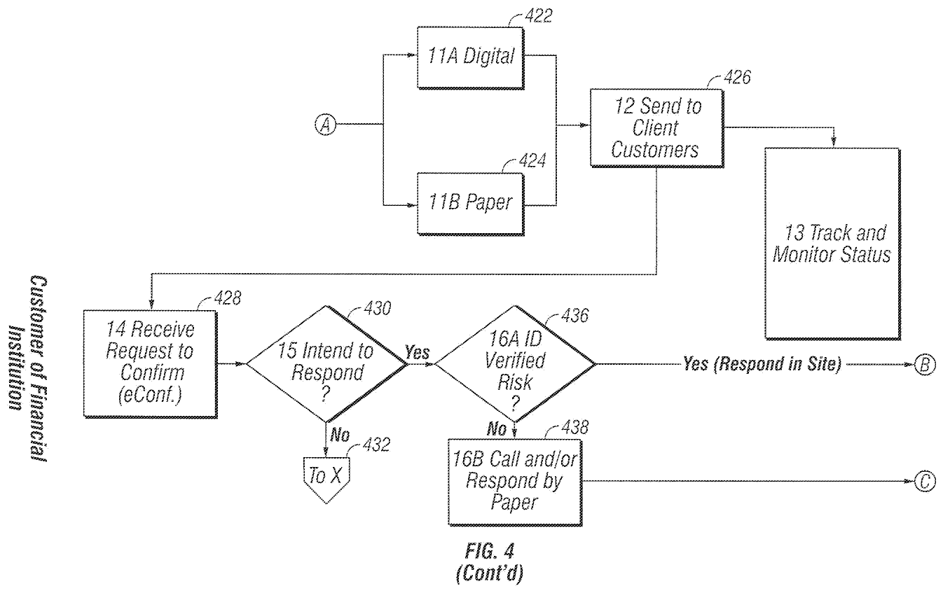

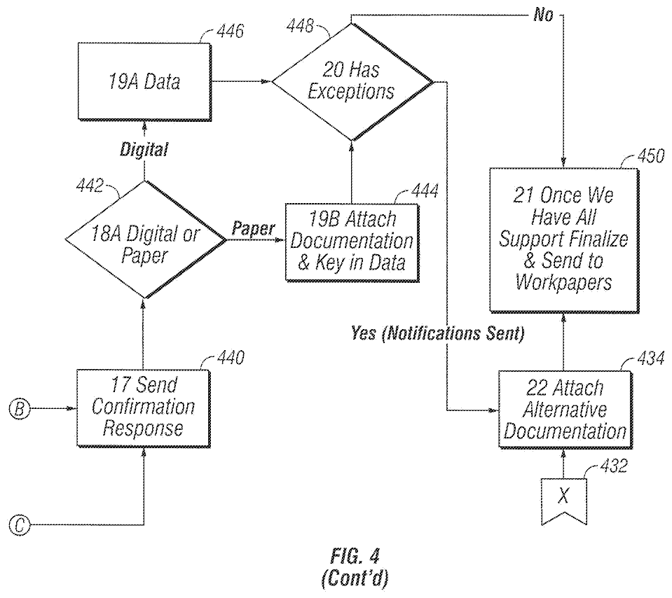

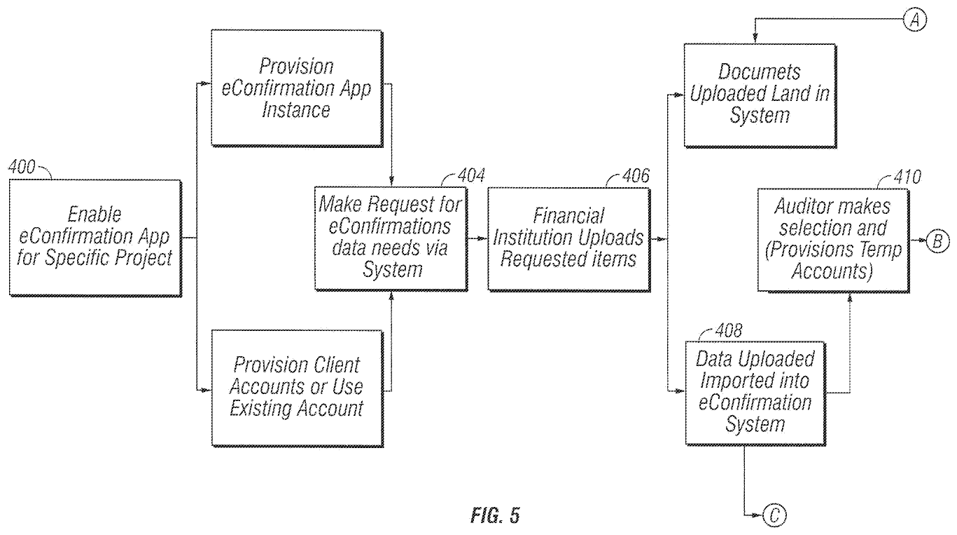

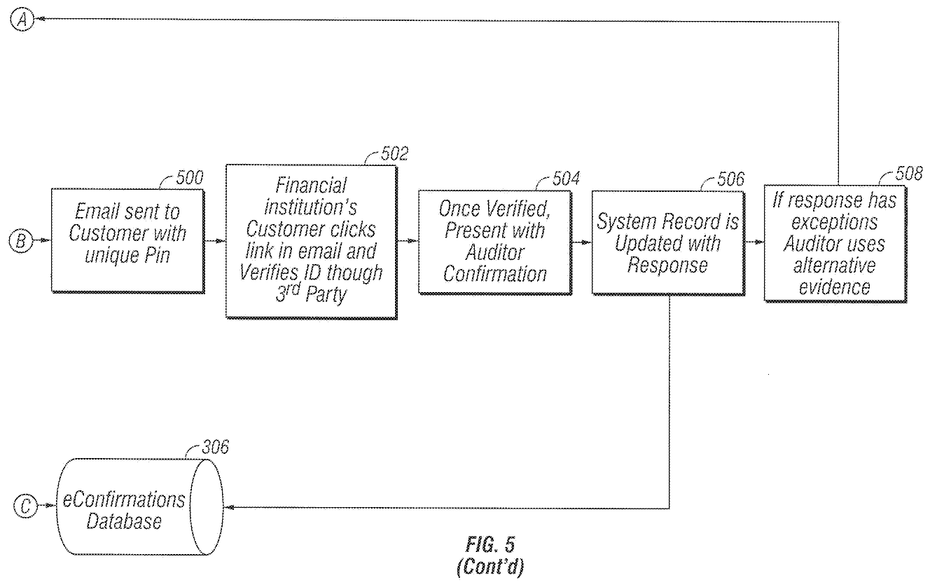

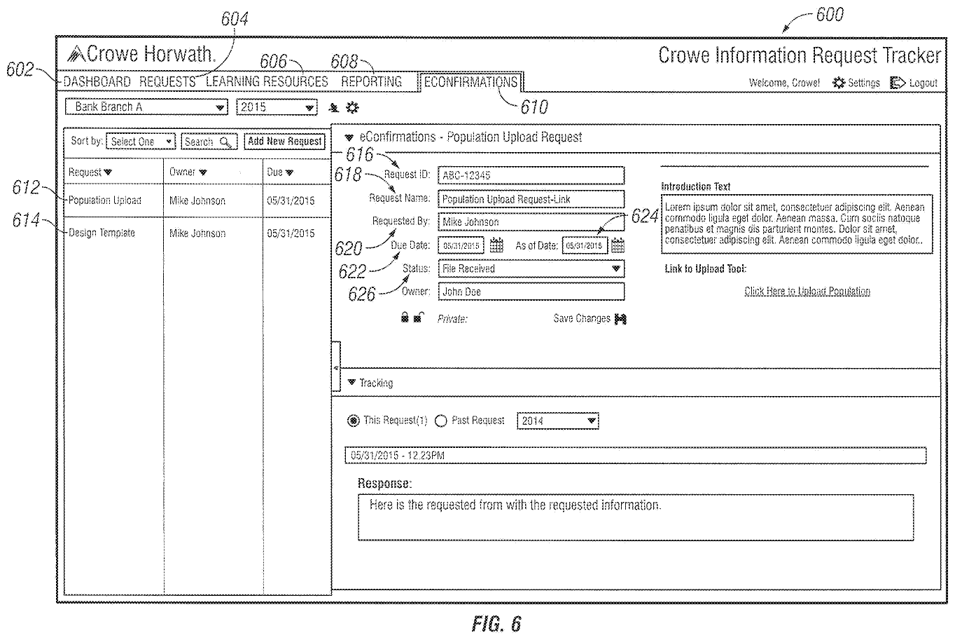

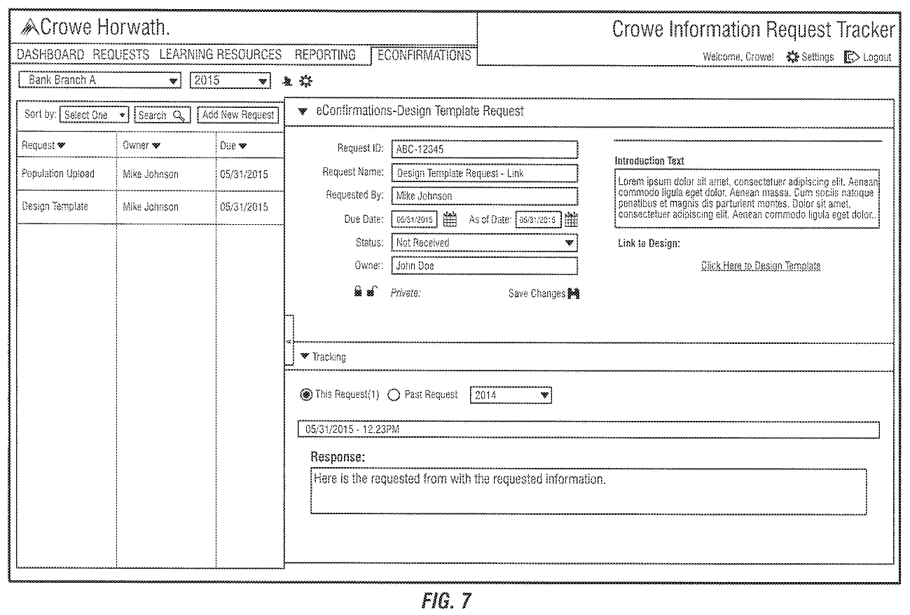

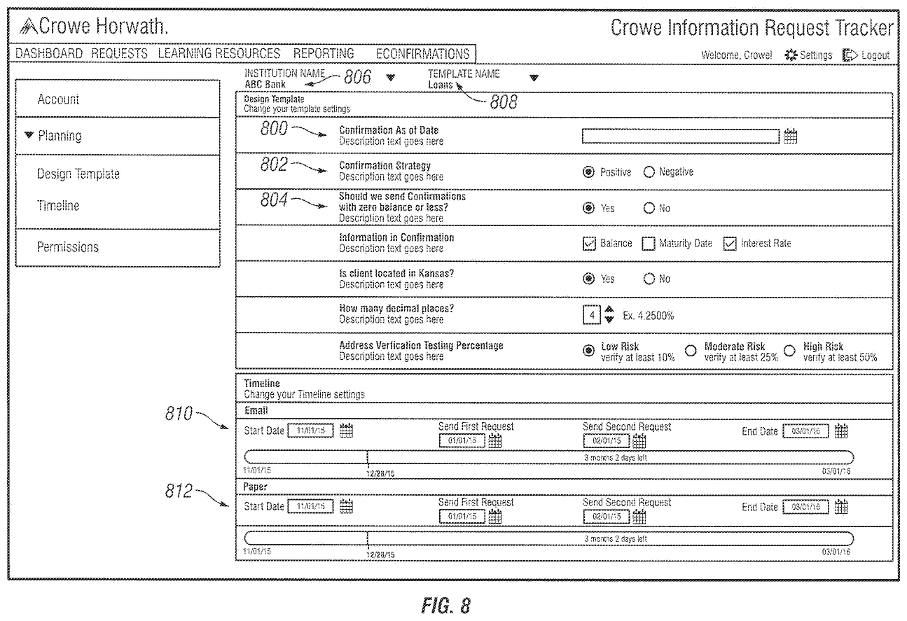

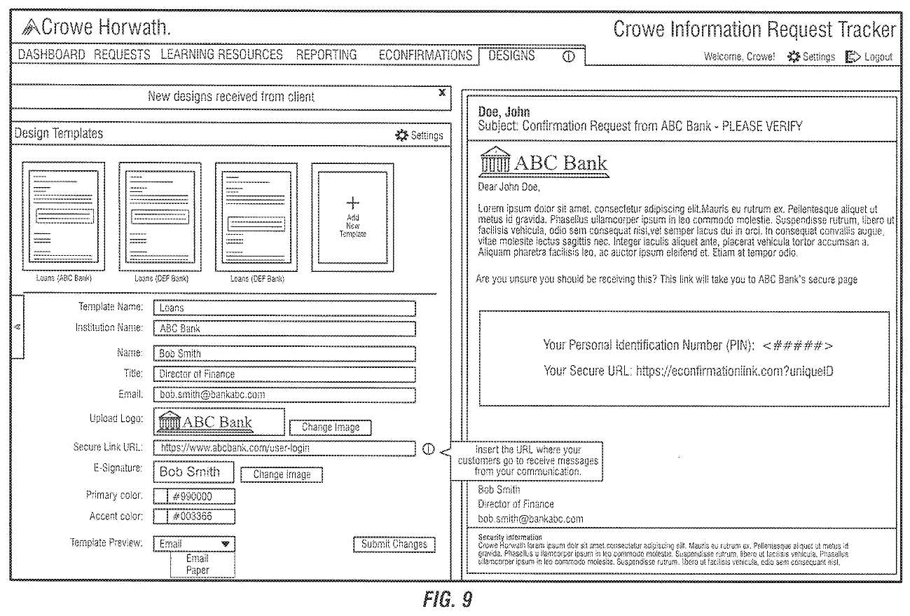

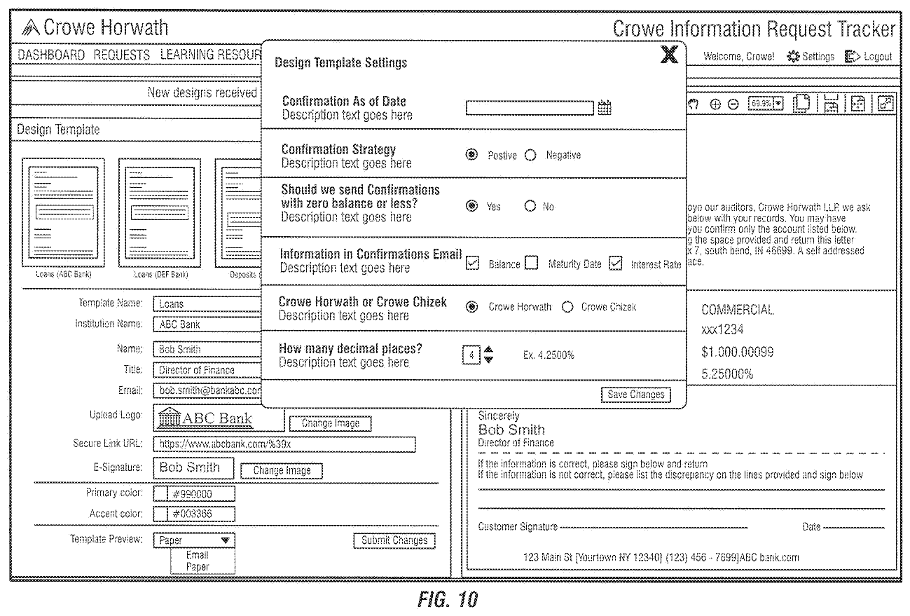

FIGS. 4 and 5 show example operations that could be performed by the accounts confirmation system 202 according to one embodiment. Upon receiving contact from a financial institution that accounts need to be confirmed for an audit, the auditor would set up an account in the accounts confirmation system 200 that would grant access to the financial institution portal 300 by the financial institution to start the project (Block 400). The auditor would then document the confirmation plan to be performed (Block 402). FIG. 6 shows an example user interface 600 for use by the auditor to perform the accounts confirmation project. In the example shown, the user interface 600 includes a plurality of sections that are selectable by the auditor. As shown, the interface includes a dashboard section 602, a requests section 604, a learning resources section 606, a reporting section 608 and an eConfirmations section 610. In this example, the auditor has selected the eConfirmations section 610. From this view, the interface shows a population upload request 612 and a design template request 614. The population upload request 612 is selected in FIG. 6 while the design template request is shown in FIGS. 7-10. In the embodiment shown in FIG. 6, the auditor may input a Request ID 616, assign a Request Name 618, who the request was made by 620, provide a due date 622, an as of date 624, as well as select a status 626. With the design template request 614, the auditor can link the design template to the same Request ID. The auditor can pick a different Request Name 618, who the design template request is from 620, a due date 622, as of date 624, and the status 626. Additionally, as shown in FIG. 8, the auditor has a number of parameters regarding the design template that can be chosen. In the example shown, the auditor can select a confirmation as of date 800, confirmation strategy 802, whether confirmations with a 0 balance should be shown 804, and other parameters. The design template can be selected based on the financial institution's name 806 as well as the template name 808. The timeline for both email 810 and paper confirmations 812 can be selected in the template. As shown in FIGS. 9-10, the content and graphical layout of the email to be sent to the financial institutions customers can be chosen. The parameters and content shown in FIGS. 6-10 are for example purposes only and this disclosure should not be limited to only those parameters for setting a population upload and design template for use by the auditor. Upon setting the population upload parameters and those of the design template, the auditor can send a request to the financial institution via the accounts confirmation system 202 (Block 404). This provides the template script for the financial institution to upload.

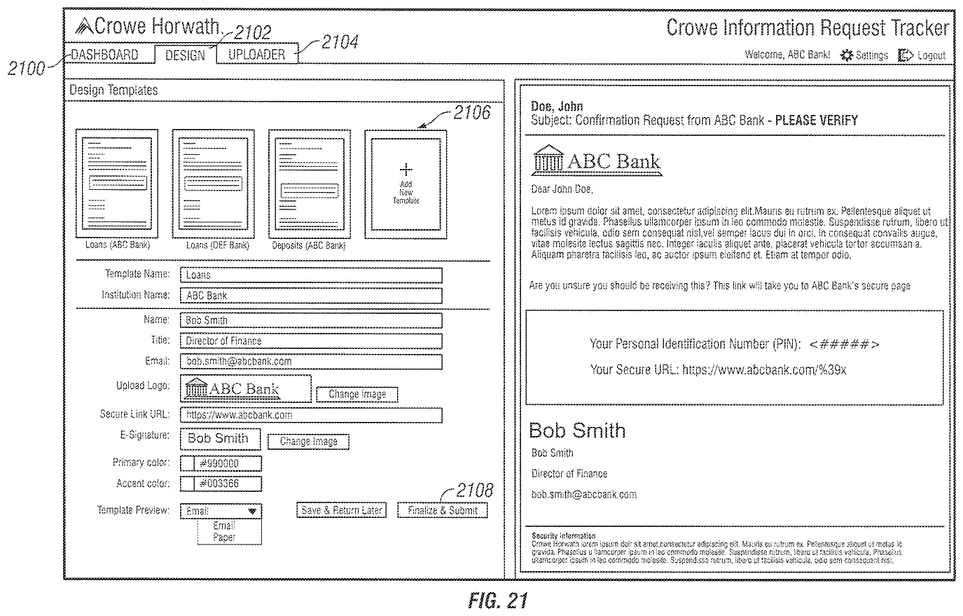

The financial institution would be provided notice that the auditor has sent a request through the accounts confirmation system 202. FIGS. 21-28 show an example interface that could be used by a representative of the financial institution to make changes to the design template provided by the auditor and upload account information to be audited. In the example interface shown in FIG. 21, the representative of the financial institution is provided with three sections from which to select. As shown, the representative can select the dashboard 2100, the design section 2102, or the uploader section 2104. In FIG. 21, the design section 2102 has been selected. This interface allows the representative to modify various parameters of the templates that have been provided by the auditor for performing the accounts confirmation. In the example shown, there is a selection section 2106 from which the representative can choose a template to be modified or add a new template. The design section 2102 also allows the representative to change a number of other parameters regarding templates, including but not limited to the template name, institution name, sender name, title and email, institution logo, institution website address, image for an electronic signature of the representative and other parameters. Upon completing modification of the template that is been selected, the representative can select a finalize button to close editing of the template and save it in the eConfirmation database 306.

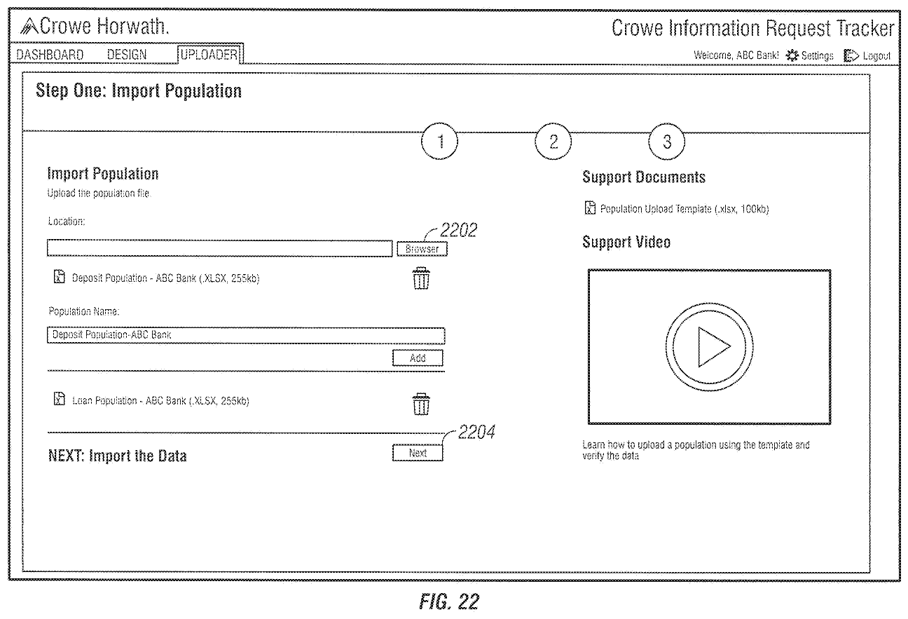

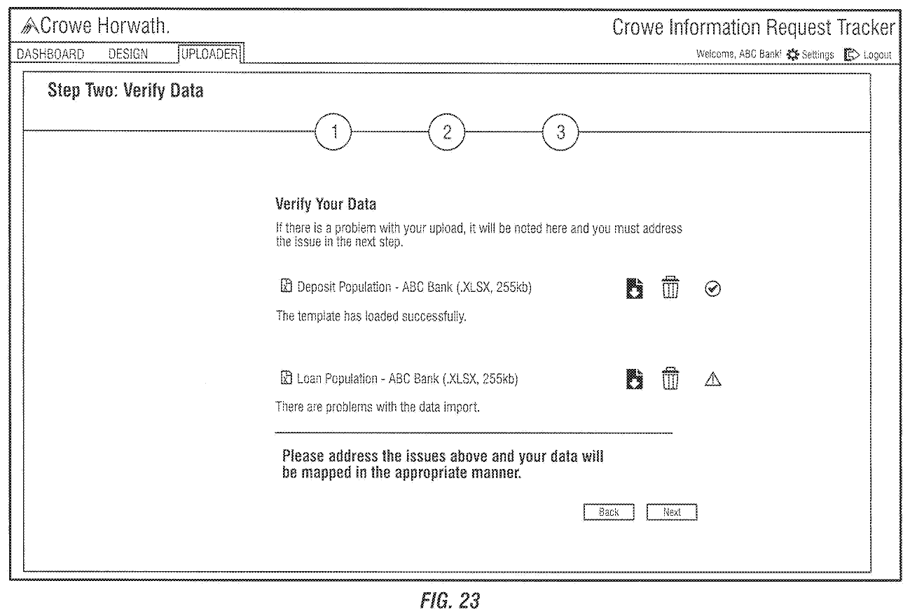

Referring to FIG. 22, the uploader section 2104 provides an interface through which the representative of the financial institution can upload data for the audit. In the example shown, the representative is presented with an interface to find a file location for deposits and loans. As shown, the interface includes a browse button 2202 that can be chosen by the representative to select a data regarding accounts. Upon selecting the files that will be submitted to the auditor, the representative would select the next button 2204 to continue the importation process, which would take the representative to the interface shown in FIG. 23.

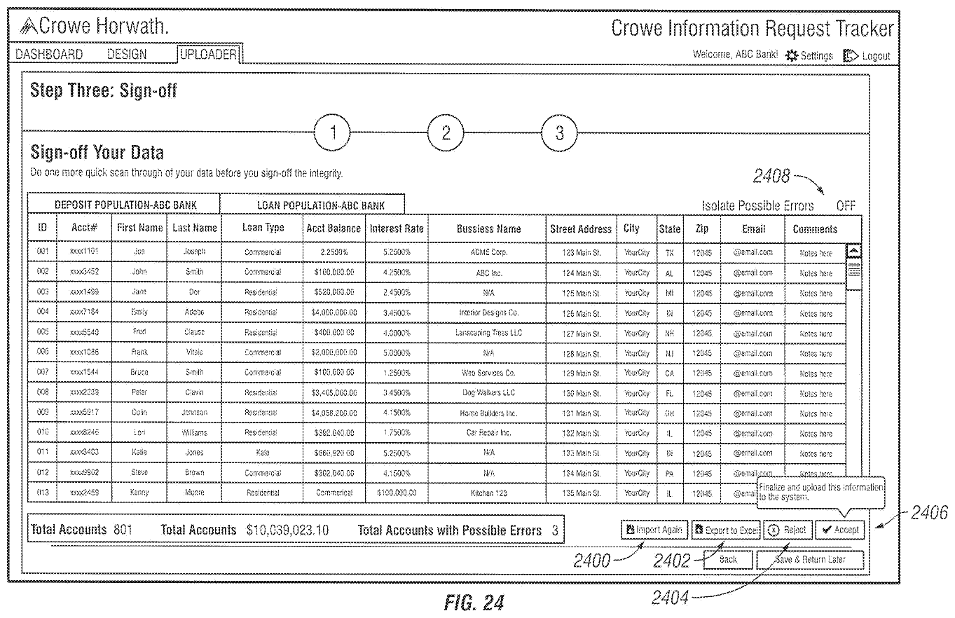

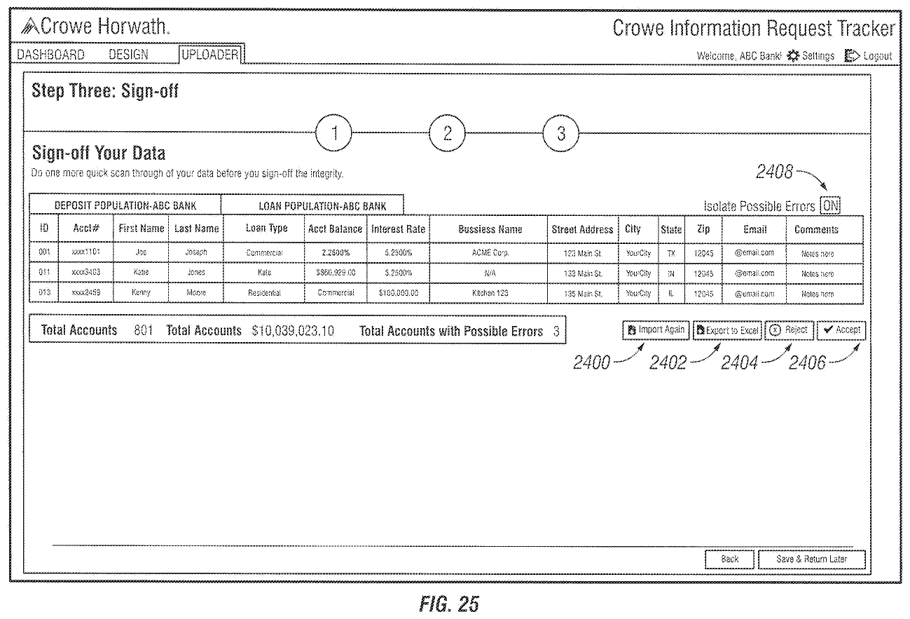

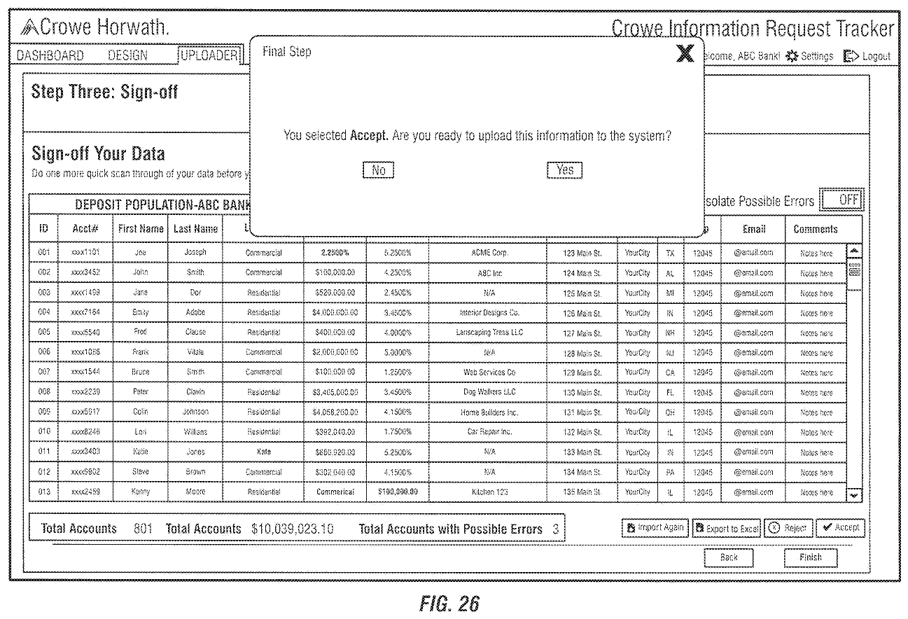

In the example shown in FIG. 23, the user is asked to verify the data to be uploaded. In some embodiments, the system will perform some analysis of the data to flag for potential errors. As shown in this example, the system has flagged potential errors in the loan population document. By selecting the next button 2300, the user is taken to the example interface in FIG. 24 that provides additional information regarding potential errors in the data. In this example, the system has flagged for potential errors in the data. For example, the system could be configured to flag items in the data that are not in the expected data type. For example, the account balance for ID 001 is a percentage instead of a dollar amount that is expected. By way of another example, the data type for ID 011 is expected to be either commercial or residential, but is a name in this example, which is flagged for a potential error. The representative can choose from a number of options in this example depending on the number of errors in the data. As shown, the representative can choose to import the data again 2400, export the data to a spreadsheet 2402, reject the data because of errors 2404, or accept the data 2406. In the example interface shown, the user may select a switch 2408 to select only those accounts that have been flagged for potential errors in data. FIG. 25 shows an example in which the switch 2408 has been turned on to filter out other accounts that have not been flagged for potential errors. Upon reviewing the data to verify integrity, the representative would select the accept button 2406 to upload the information to the eConfirmation database 306. In some cases, the representative could receive an additional warning, such as shown in FIG. 26, prior to uploading the data. This design template review and uploading of the data population is shown in FIG. 4 in Block 406, which stores the data in the eConfirmation database 306 (block 408).

The auditor would then review the population data uploaded by the financial institution to select a sample for the accounts confirmation process (block 410). The system will alert the representative that a sample has been chosen (block 412).

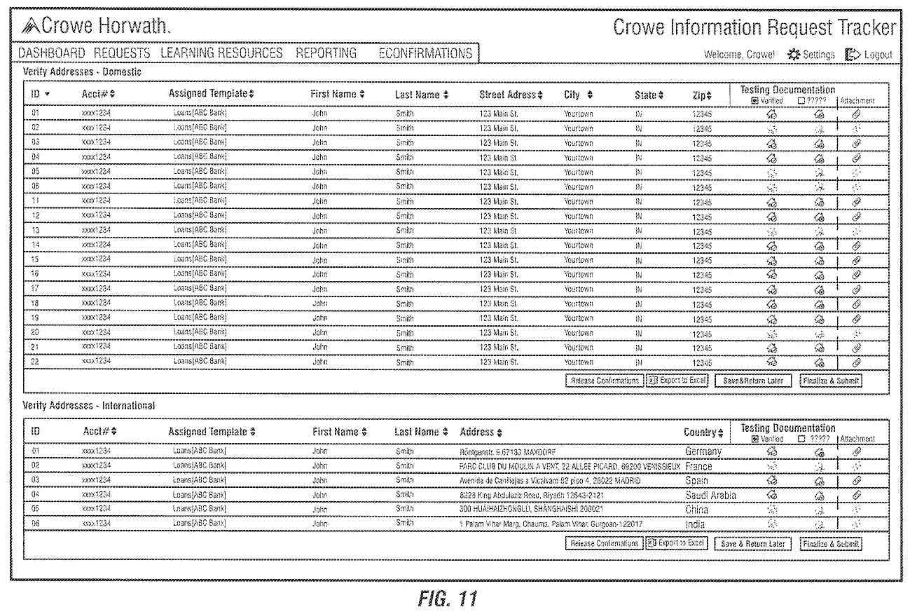

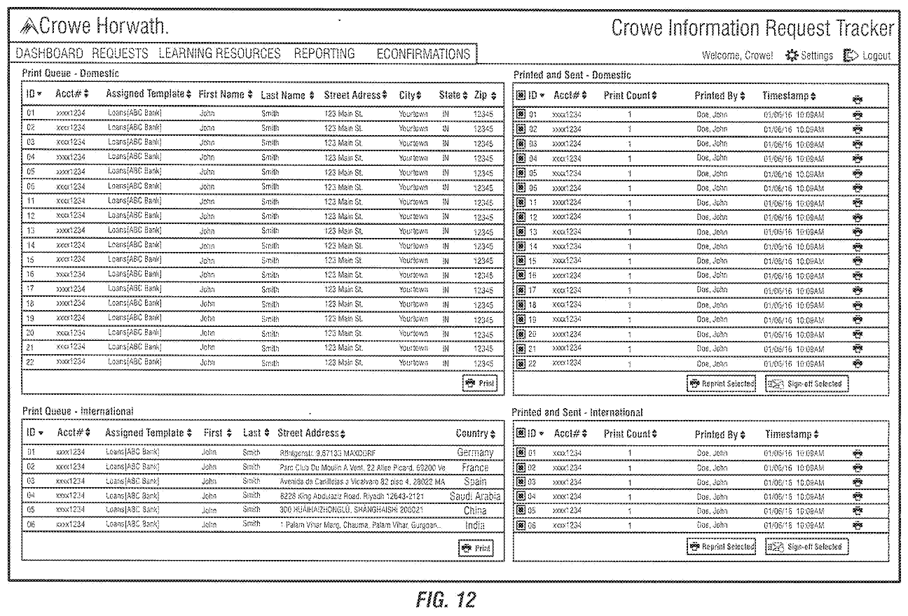

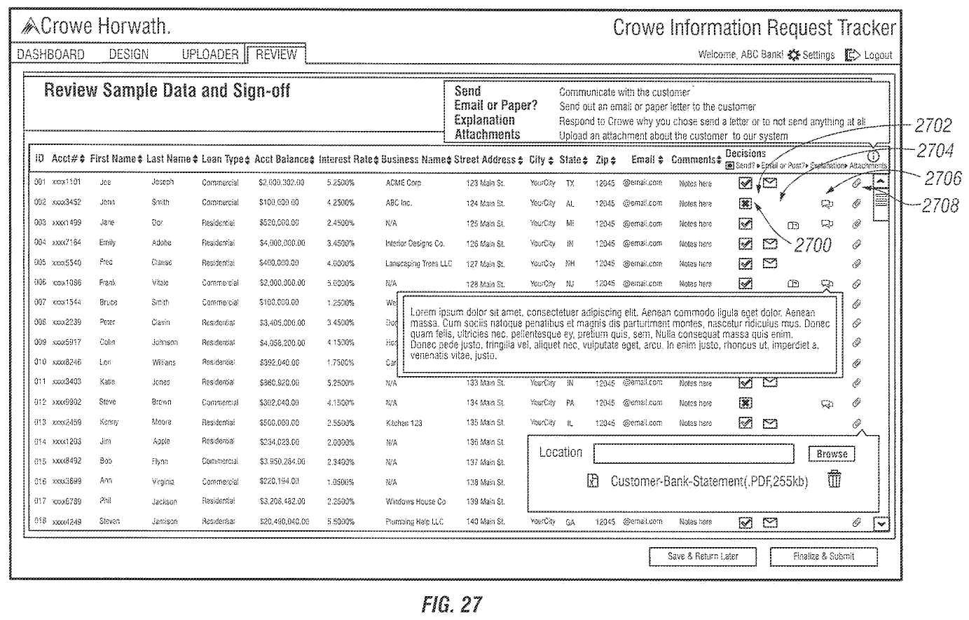

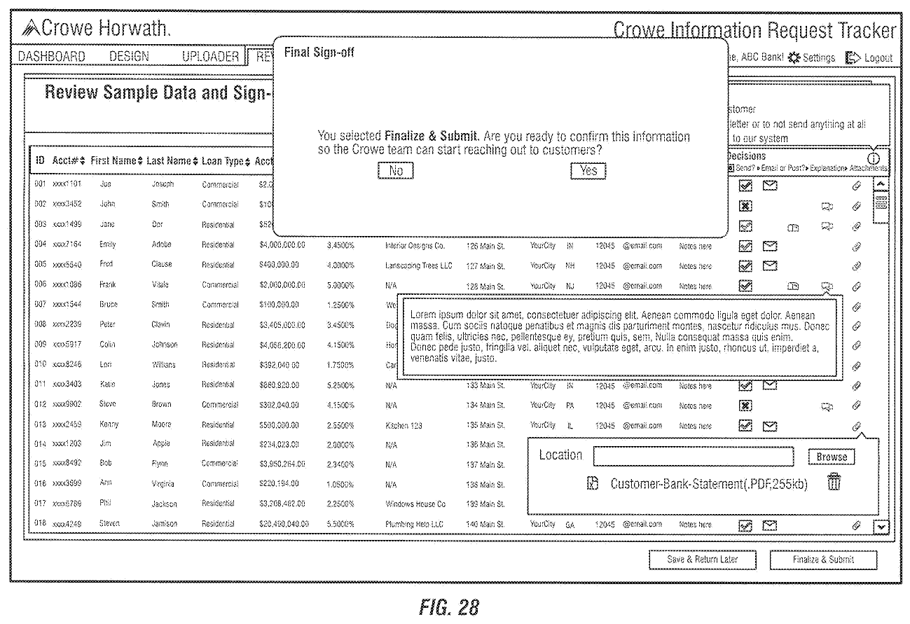

FIG. 27 shows an example interface that could be provided to the representative of the financial institution to review the sample data communicated by the auditor. In the example shown, the auditor may select whether to not communicate with particular customers, choose between an email communication or paper to the customer, provide an explanation to the auditor as to why to send a paper letter or no letter at all to the customer, and provide attachment documents. In the interface shown, there is a column for the representative to deselect customers for which no communication should be made, which is shown as an “X” in the example interface. There is a selection as to whether to use email 2702 or paper 2704 in the communication. A column is provided for bringing up a dialog box to provide an explanation 2706. Finally, there is a column for attachments related to each account 2708. Upon making the selections with the sample data, the representative can select the finalize and submit button 2710 to submit this information to the auditor. In some cases, the system may ask the representative to confirm the selections as shown in FIG. 28. By selecting the finalize and submit button 2710, this will store the selections in the eConfirmation database 306 (block 418). The refinement of the design template and review of sample data by the financial institution's representative are shown in Blocks 414 and 416 of FIG. 4. The auditor would then produce confirmations (block 420) which could either be in digital (block 422) or paper (block 424) form. As part of producing these confirmations, FIGS. 11-12 show an example interface for verifying addresses and printing the confirmations. As shown in Block 426, the confirmations are then sent to the selected customers of the financial institution.

For customers of the financial institution receiving an electronic confirmation, this could be in the form of an email with a unique PIN number (Block 500 in FIG. 5). In some embodiments, for example, the email may include a link for the customer to select to verify their identity. The link could be the network address of third-party ID verification server 326 that could verify the identity of the customer or the link could be to the auditor's website that includes software embedded in the website that communicates with the third-party ID verification server 326 (block 502). Once the identity of the customer has been authenticated by the third-party ID verification server 326, the customer would be presented with information about their account to confirm (block 504). The system would update the confirmation database 306 with the answers of the customer (block 506). If the responses by the customer have any exceptions (e.g., information that is not accurate according to the customer), the account will be flagged as an exception for the auditor to use alternative evidence of the account information (block 508). Referring again to FIG. 4, the customer would receive an email requesting that they confirm certain information about their account (block 428). In some cases, a determination may be made as to whether the customer intends to respond (block 430). If it is determined that the customer has no intention of responding (block 432), the auditor would attach alternative documentation to confirm the account information (block 434). In some cases, a determination can also be made as to whether there is a risk regarding the identification of the customer (block 436). If the risk is above a predetermined threshold, the confirmation will be performed through non-electronic means, such as by having the customer call or respond by paper (block 438). The confirmation response of the customer will be sent to the system (block 440). A determination will be made as to whether the response is made in paper or electronically (block 442). If the responses were made by paper, the documentation may be scanned or data entered into the system (block 444). Otherwise, the electronic responses are stored in the system (block 446).

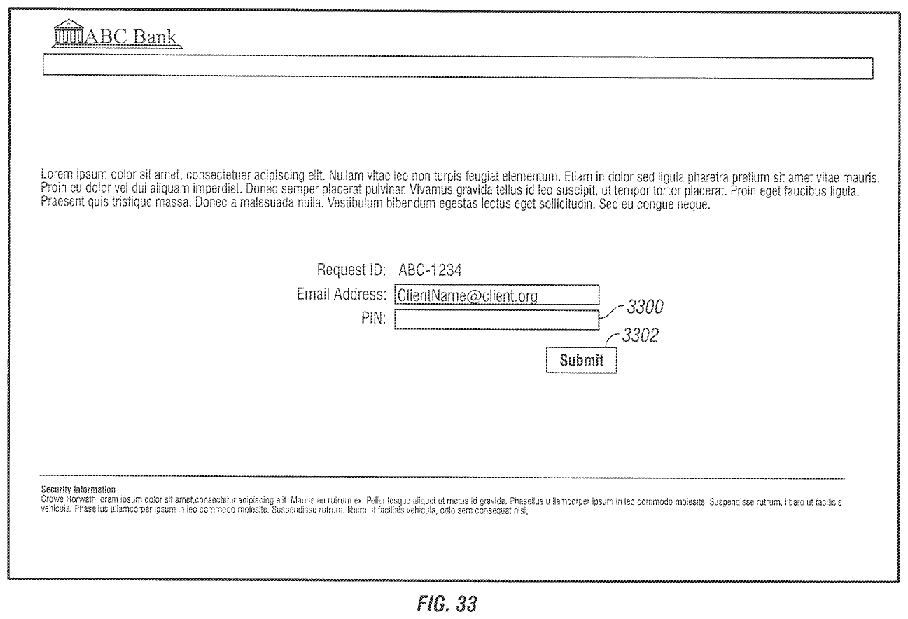

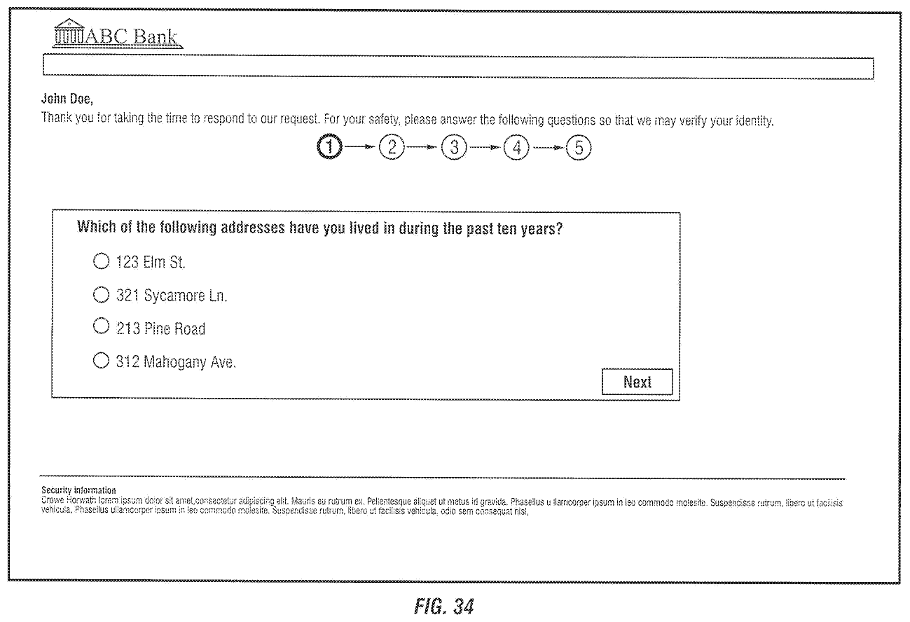

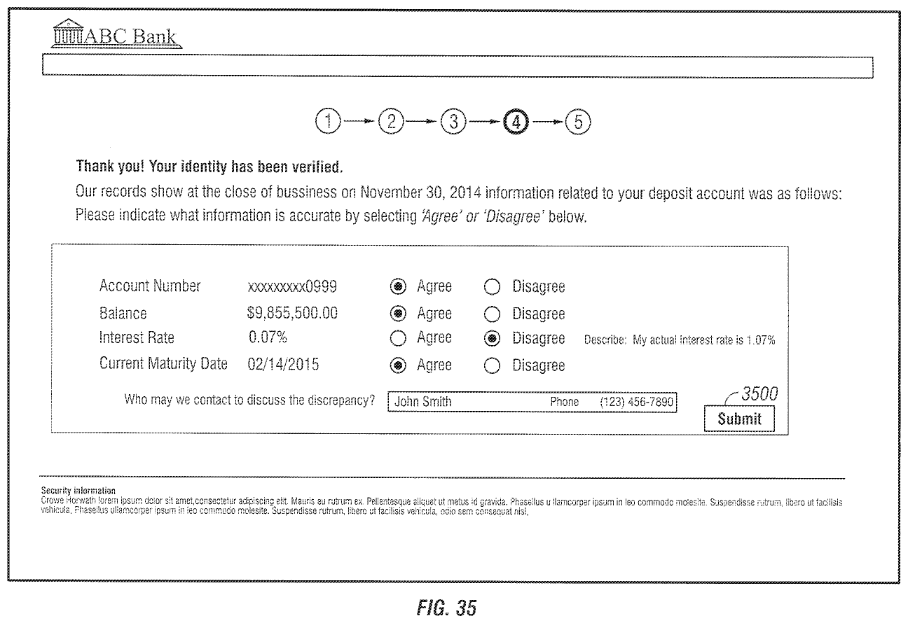

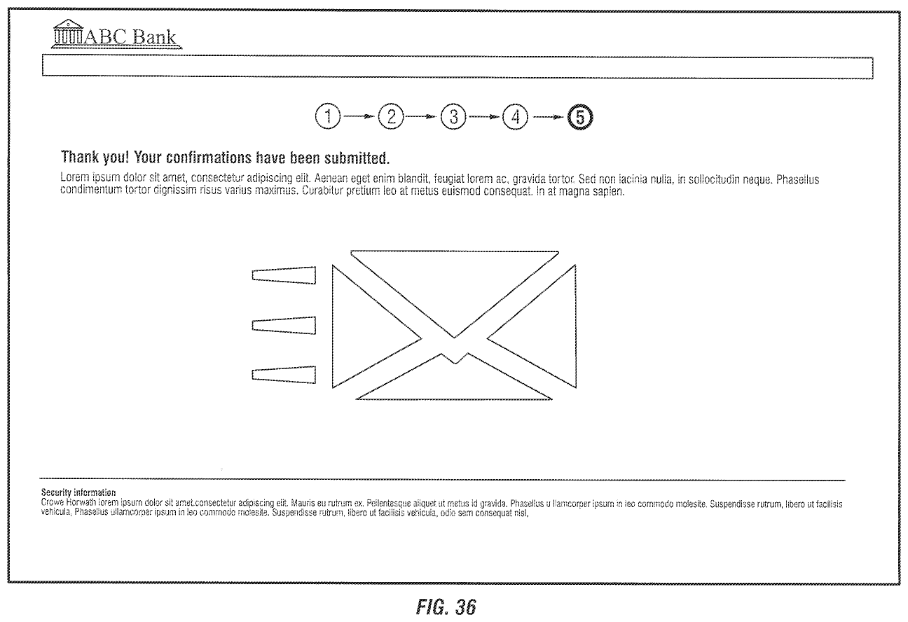

FIGS. 33-36 show an example interface to which the customer of a financial institution may be presented upon selecting the link in the email as described above. As shown, the interface includes a text box 3300 for the user to supply the PIN code provided in the email. Upon selecting the submit button 3302, the user may be sent to the third-party ID verification server 326 or the website may include code embedded to communicate with the third-party ID verification server 326. In the example shown in FIG. 34, the customer is asked a security question that will help verify the identity of the customer. If the customer successfully verifies its identity, a confirmation screen, such as shown in FIG. 35, could be provided. In this example, the customer is asked to confirm the account number, balance, interest rate, and current maturity date by agreeing or disagreeing with the information provided. In the embodiment shown, the customer may describe why there is a disagreement with the information provided. Upon filling in the confirmation information, the customer would select the submit button 3500 to send the confirmation responses to the system. FIG. 36 is an example screenshot of an interface that could be shown to the customer upon submitting the confirmation responses to let the customer know that the response has been submitted to the system. A determination is made by the auditor whether there are exceptions in the responses to the accounts confirmation requests (block 448). If there are no exceptions, the accounts confirmation audit is finalized and stored in the system (block 450). If there are exceptions in the responses, the auditor would attach alternative evidence for those accounts in the system.

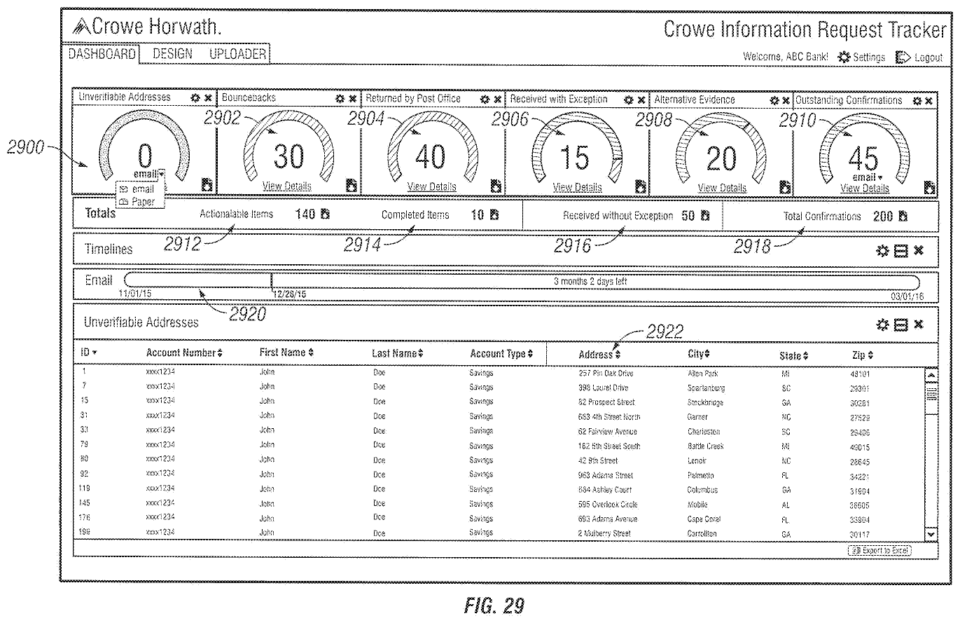

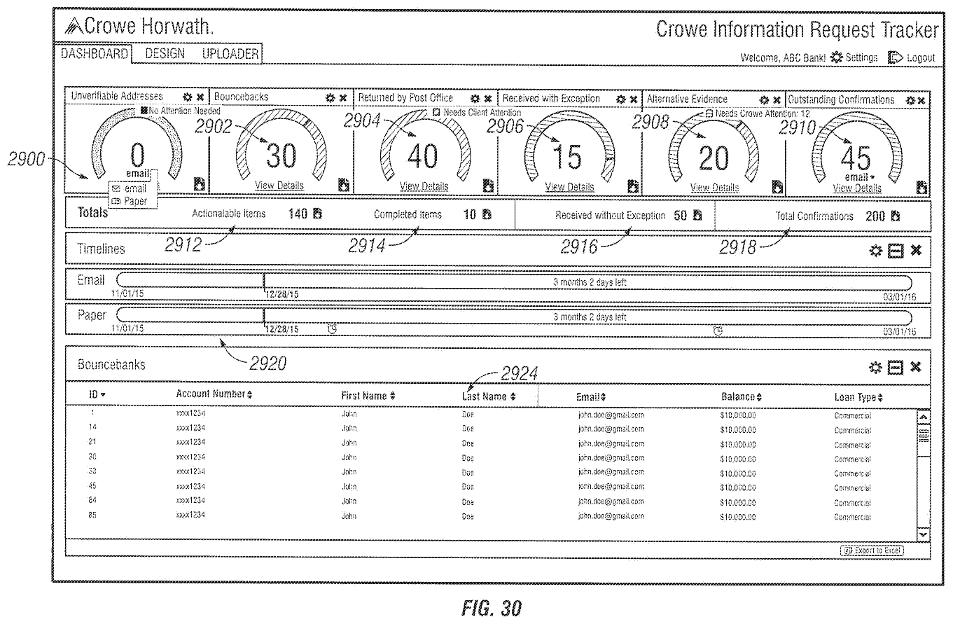

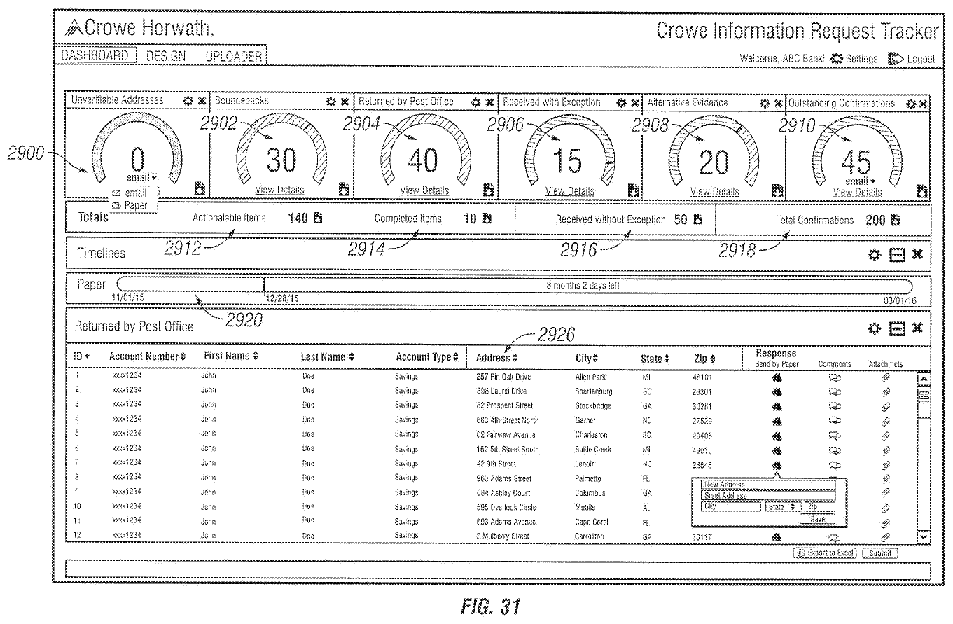

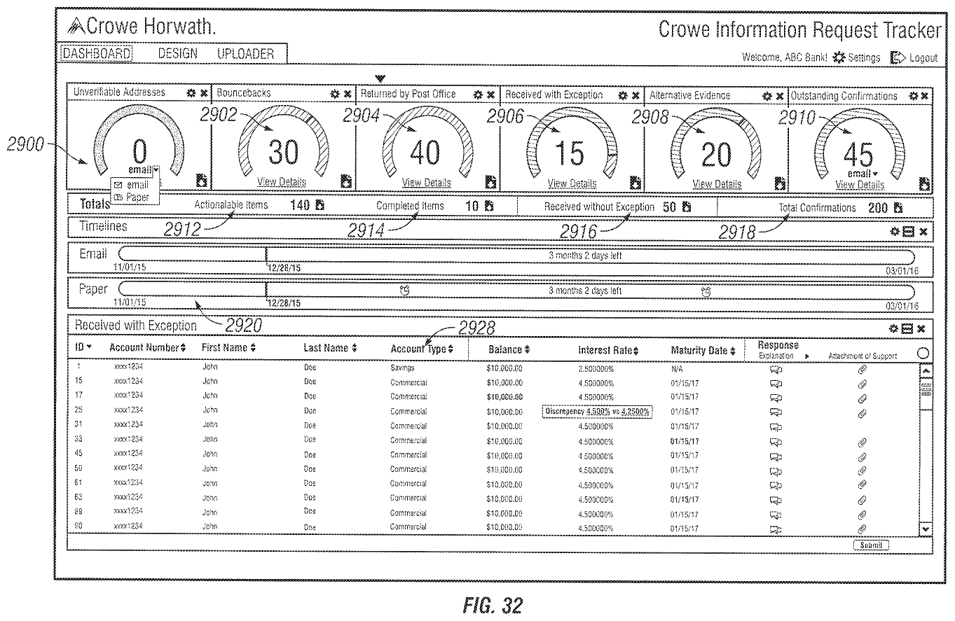

During the accounts confirmation process, the accounts confirmation system 202 includes a dashboard showing a substantial real-time view of various metrics regarding the accounts confirmation status. FIGS. 29-32 show an example interface with a dashboard for use by the financial institution according to an embodiment of this disclosure. In the example shown, the dashboard includes a plurality of gauge-like graphics showing respective metrics of the ongoing accounts confirmation process. As shown, the dashboard includes the following example gauges: unverifiable addresses 2900, bouncebacks 2902, returned by the post office 2904, received with the exception 2906, alternative evidence 2908, and outstanding confirmations 2910. In the example shown, the gauges display whether that particular metric is within an acceptable range based on a graphic, such as color, crosshatching, etc. This allows a high level view to a representative of a financial institution to view the status of the accounts confirmation process at a glance based on gauges. The information displayed in the dashboard can be updated in a substantially real time process as customers respond and the auditor updates information in the system. Accordingly, this eliminates the need for the auditor to provide status updates since the financial institution will be updated with the status based on the dashboard. Moving downward in the example shown, the dashboard includes totals regarding actionable items 2912, completed items 2914, items received without an exception 2916, and total confirmations 2918. The dashboard also includes a timeline 2920 from which the status progress of the accounts confirmation process, along with the time remaining, can be seen. If the representative wishes to review more detailed information regarding status, each of the gauges in the dashboard can be user-selectable to reveal a detailed table showing items related to that gauge. For example, FIG. 29 shows an example in which the user has selected the unverifiable addresses gauge 2900, which provides a table 2922 showing each of the accounts for which the address is currently unverifiable. FIG. 30 shows an example in which the representative has selected the bouncebacks gauge 2902, which shows a table of those accounts containing bounce backs 2924. FIG. 31 shows an example in which the representative has selected the returned by the post office gauge 2904, which shows a table 2926 of accounts for confirmation requests that were returned by the post office. FIG. 32 shows an example in which the representative has selected the received with exception gauge 2908, which shows a table 2928 of those accounts for which there is an exception.

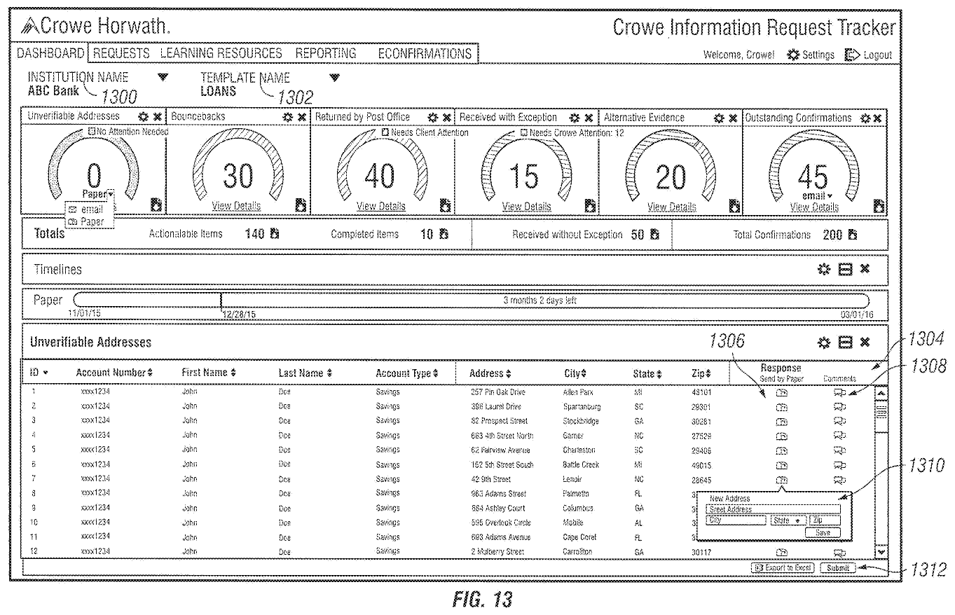

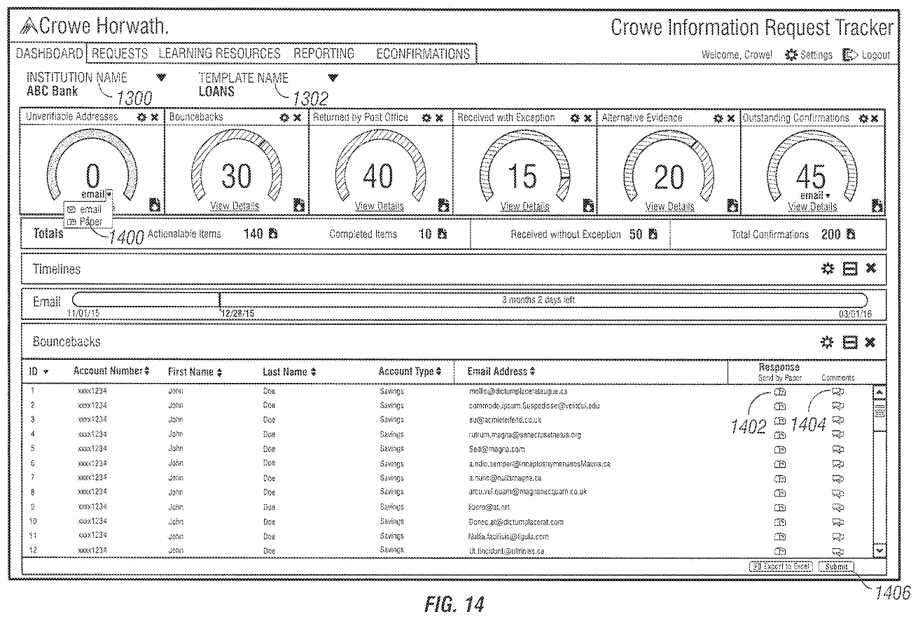

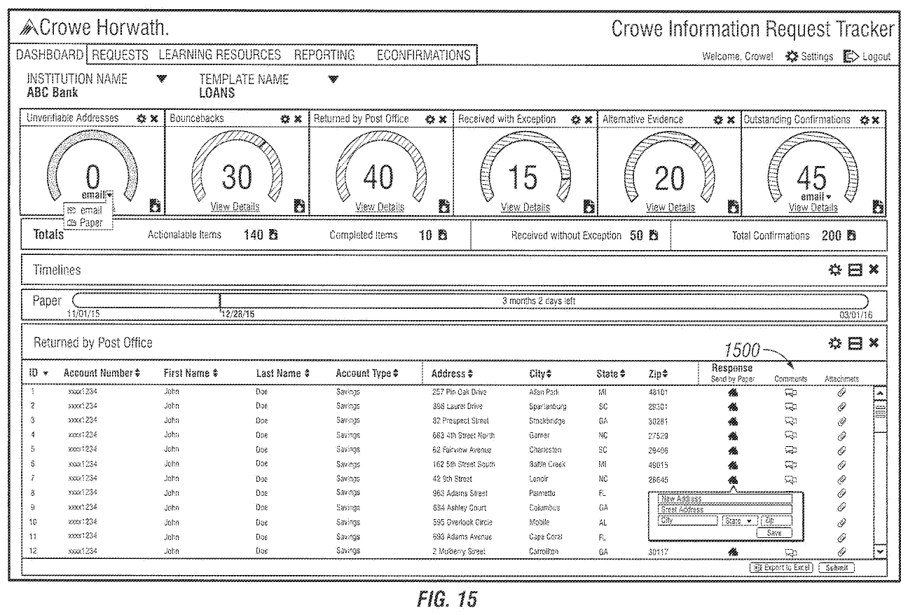

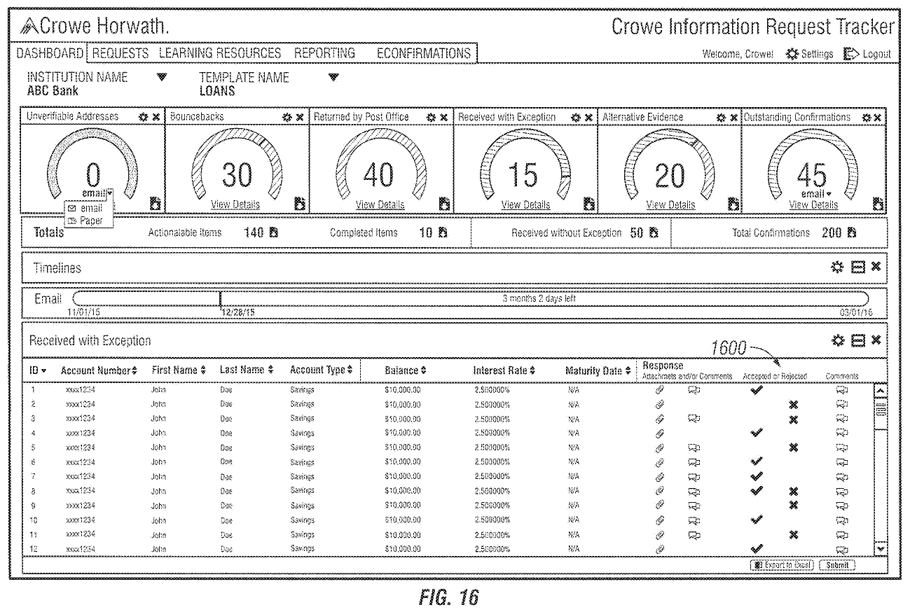

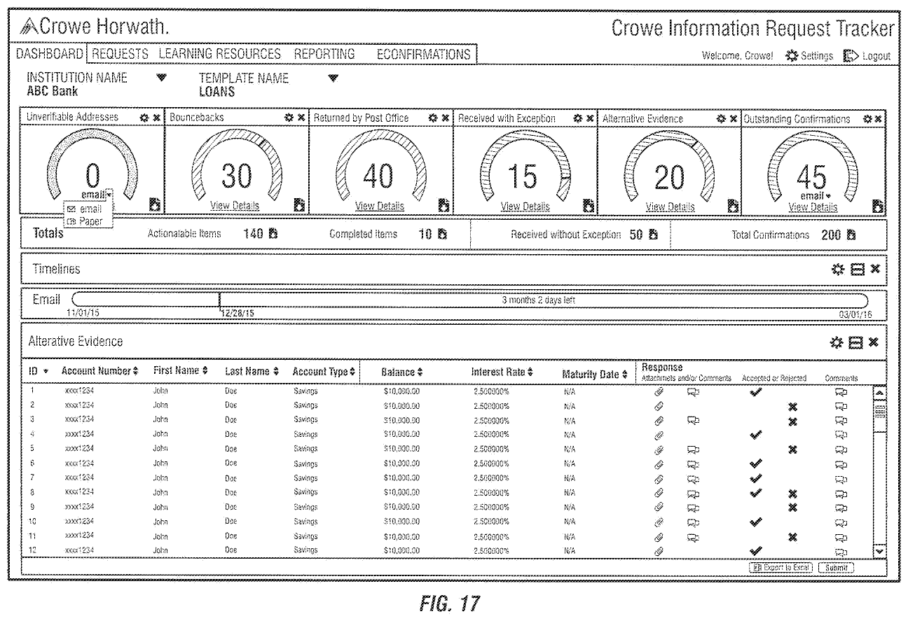

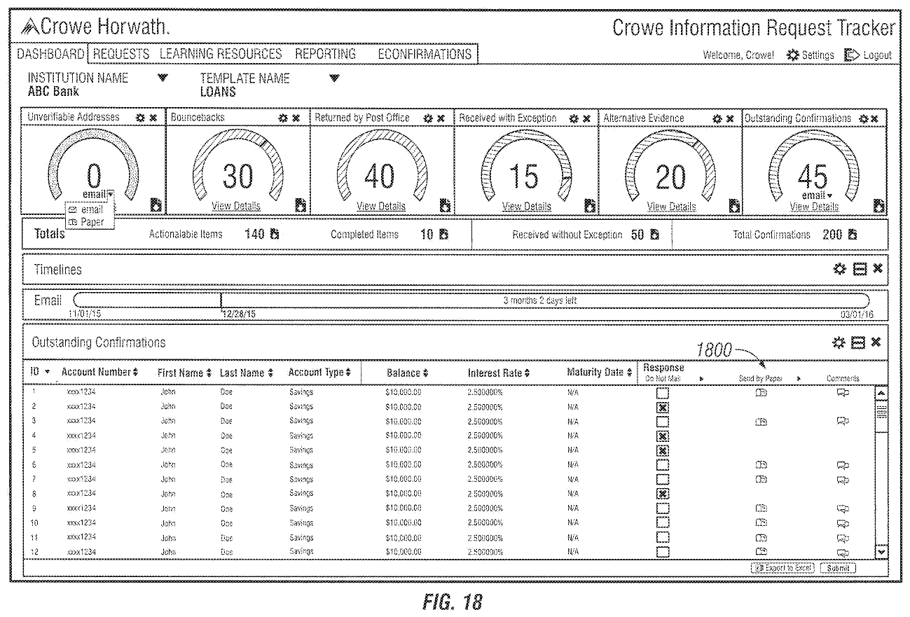

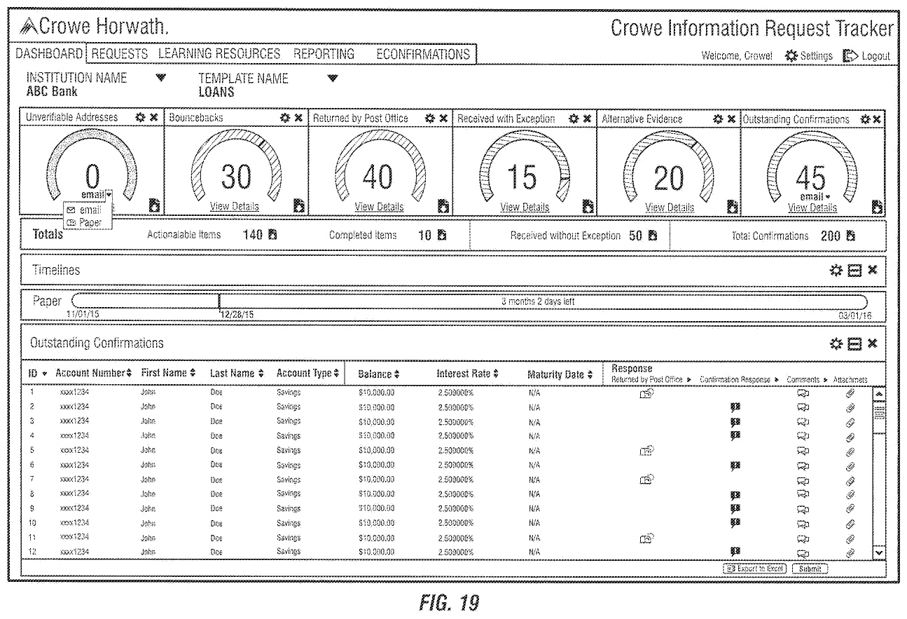

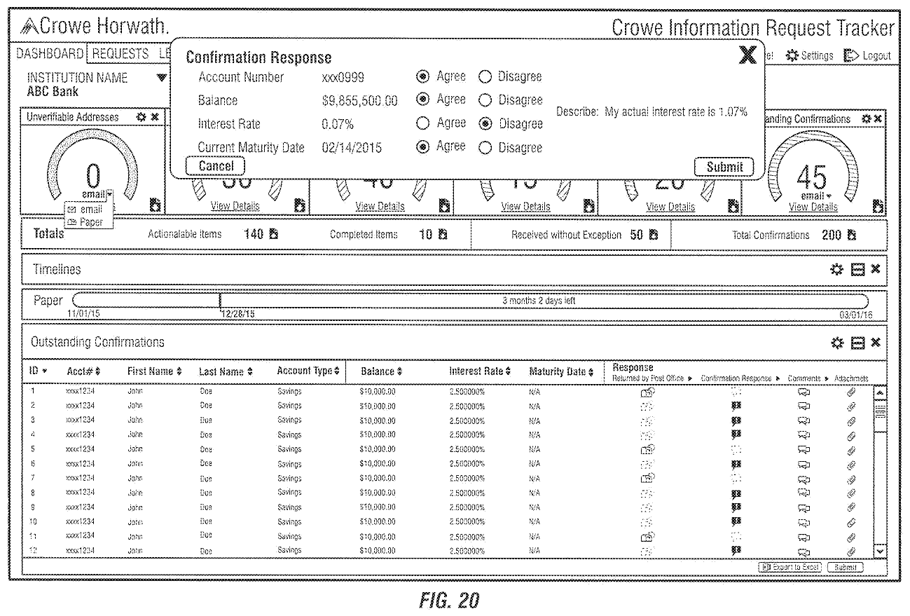

FIGS. 13-20 show an example interface of a dashboard for use by the auditor. In the example shown, the dashboard includes gauge-like graphics similar to the dashboard described above with respect to the financial institution. However, the dashboard for use by the auditor has some additional capabilities to modify the status and/or make changes in comments regarding accounts being confirmed. For example, the auditor can select a financial institution 1300 and template name 1302 from which the dashboard pulls data. There is also a response section 1304 for the auditor to fill in information about the various accounts. For example, after selecting the unverifiable addresses gauge, the auditor is presented with a response section 1304 from which the auditor can select a send by paper button 1306 and a comment button 1308. By selecting the send by paper button 1308, the auditor may be presented with an interface 1310 from which a new address can be entered for the account. The comment button 1308 could be provided for the auditor to provide any comments that are needed or necessary related to the respective accounts. Upon making any changes the auditor would like, the dashboard includes a submit button 1312 to save any changes that have been made. The example dashboard shown in FIG. 14 shows an example interface upon selection of the email tab 1400 regarding on verifiable addresses. In this example, the auditor is presented with a address button 1402 from which the email address associated with the account can be updated. Likewise, a comments button 1404 is provided for the auditor to enter any comments regarding an account. The auditor can select the submit button 1406 to save any changes made in this view. FIG. 15 shows an example interface upon selecting the returned by post office gauge. As with the other dashboard interfaces described above, this interface includes a response section 1500 from which the auditor can make comments and provide information regarding accounts from which the request were returned by the post office. FIG. 16 shows an example interface upon selecting the received with the exception tab. In this example, the auditor may accept or reject an account exception 1600 in addition to comments as discussed above. Similarly to FIG. 16, FIG. 17 shows an interface from which an auditor may accept or reject accounts regarding alternative evidence. FIGS. 18 and 19 shows an example interface upon selection of the outstanding confirmations gauge. This interface, similarly to those described above, includes a response section 1800 from which the auditor can include information or make changes regarding an account being confirmed. FIG. 20 shows an example in which the auditor has selected an account to view the confirmation response.

Consider an example in which an auditor is asked to help a bank's confirmation efforts. The auditor will complete planning documentation for confirmations and start the confirmation process. This process could start with a document confirmation plan using the accounts confirmation system 202 (Block 402 in FIG. 4), such as using the interface shown in FIGS. 6-10. The auditor would make the decisions regarding the confirmation plan, which would be documented in the system 202. For example, the auditor could use the system 202 to document the different account types, or create new account type(s), that confirmation testing will be performed on, and choose to either apply the planning considerations to a group of the account types, or can apply the planning considerations for each individual account type, including but not limited to mortgage loans, commercial loans, lines of credit, credit cards, participation loans, demand deposits, individual retirement accounts (IRAs), and other types of accounts. The auditor could decide whether positive or negative confirmations will be utilized, such as using the interface 804 in the example shown in FIG. 8. If negative confirmations are utilized, confirmation method could default to paper and a default could be provided to only send one confirmation with no follow up option. The auditor could use the system to select the information in which to confirm (there could be standard options, as well as an option to add customized non-standard items), such as: balance, maturity date, interest rate, terms of the agreement, contracts, transactions between entities and other parties, specific invoices, absence of certain conditions, such as side agreements, etc. The system could be used to select certain design options. For example, if maturity dates are being confirmed, the auditor can select whether accounts that have maturity dates prior to the confirmation date should be confirmed. By way of another example, if interest rates are being confirmed, the auditor could select how many decimal places should be confirmed. The auditor could also select the dates in which confirmation requests, and follow ups will be sent. Upon completing the planning section of the system 202, the auditor can mark the planning section completed.

With the confirmation plan created, the auditor can request documents from the financial institution (Block 404 in FIG. 4). For example, the auditor can use the system 202 to request the general ledger from the client. In some cases, the auditor can request subsidiary ledgers from the financial institution for each account type that has distinct plan considerations associated with it. The auditor, in some cases, could assign the contact at the financial institution that should respond to the request. In some embodiments, the request could include various parameters, such as due date, whether the request should be private (i.e., only be visible to the individual from whom the information is requested), attachments with example documents, instructions for the request, etc. In some embodiments, the auditor can monitor the status of responding to the request. For example, the auditor could update the status of the request in the system to “completed” or “acknowledged.”

The representative of the financial institution will be notified through the system 202 with the request, along with any deadline assigned to the request. In some embodiments, the system 202 could allow the representative to assign the request to another person in the financial institution that has access to the system 202. With the request submitted through the system 202, the representative could see the status of the request on the dashboard 314. The representative would attach information requested by the auditor and send this information to the auditor through the system 202 (Block 406 in FIG. 4).

The files provided by the financial institution can be loaded into the eConfirmation database 306 (Block 408 in FIG. 4). In some embodiments, the auditor can map the information provided to the standard fields in the system 202. For example, the files provided by the financial institution could be mapped to the following fields: account number, account name, customer type (business or individual), primary customer/member name, secondary customer/member name, tertiary customer/member name, mailing address, e-mail address, account balance, invoice number, invoice date, invoice balance, payment terms, note number, maturity date, interest date, account in bankruptcy, do not mail account, do not e-mail account. In some embodiments, the system 202 allows the auditor to generate an exception report of any accounts that do not include all required fields. For example, the auditor could drilldown into each individual exception to get additional detail to access and resolve the exception. If the exceptions are substantial because the financial institution provided a file that is inadequate, the system allows the auditor to purge the file that was loaded from the system.

In some embodiments, the auditor may reconcile the subsidiary ledgers with the general ledger (e.g., to see if totals and descriptions are consistent), and generate a sample selection (Block 410 in FIG. 4). For example, the auditor could perform the sample generation on a single account type or multiple account types, and could select which ones to perform the sample selection for. In some embodiments, the auditor could run multiple different sample populations. In some cases, the auditor can select certain criteria that will impact the way the sample is generated. After the sample population has been generated, the system 202 can identify, based on the mapping criteria, accounts from the sample population (such as accounts in bankruptcy) for which confirmation requests are not needed, but instead the auditor will alternatively test the account information. An alert that the sample population has been sent through the system 202 is sent to the financial institution (Block 412). The representative of the financial institution can review the population for “Do Not Mail” accounts and approve or modify confirmation template(s) (Blocks 414 and 416 of FIG. 4). In some cases, there could be a default reason for the representative to choose to explain why certain customers should not be mailed the confirmation request, such as at client request, account in bankruptcy or contract negotiations. Prior to producing confirmations, the mail addresses could be verified, such as using an interface similar to that shown in FIGS. 11 and 12. The confirmation requests are then sent digitally and via paper to customers (Blocks 422 and 424 of FIG. 4). The status of each of the confirmation requests can be reviewed by both the auditor and representative of the financial institution via each respective dashboard. The auditor can also update information regarding each of the confirmations. For example, the auditor can select a response type for each request, such as confirmed without exception, confirmed with exception, post office return, do not mail, and no reply. For tracking purposes, the system 202 is able to identify the auditor that has modified records in the system, along with signing off with the confirmations.

What is claimed is:

1. An accounts confirmation system for confirming accuracy of financial information in an account of a customer of a financial institution, the accounts confirmation system comprising:
a data source having stored thereon data regarding a plurality of accounts of a financial institution to be confirmed, wherein the data source regarding the plurality of accounts comprises existing financial data of an existing account of an existing customer of the financial institution; and
a server in data communication with the data source, wherein the server includes a computer program embedded in a computer readable medium comprising computer executable instructions for execution by a processor, the computer program comprising:
instructions to determine a customer email address associated with the existing account of the existing customer to be confirmed from the plurality of accounts of the financial institution;
instructions to generate an email to the customer email address seeking confirmation of data regarding the existing account of the existing customer to be confirmed, wherein the email includes: (1) a link to a network address of a third-party ID verification server configured to verify an identity of a person associated with the customer email address is the existing customer; or (2) a link to a network address that includes embedded software configured to communicate with the third-party ID verification server through an application programing interface (API), wherein the instructions are configured to exclude any of the existing financial data of the existing customer's account from the email;
instructions to determine a score representing a confidence level with which the third-party ID verification server verified the identity of a person associated with the customer email is the existing customer;
instructions to present a user interface from which the existing customer can electronically confirm whether at least a portion of the existing financial data of the existing customer's account retrieved from the data source is accurate by interacting with the user interface, wherein the existing financial data regarding the existing customer's account retrieved from the data source is presented responsive to the score exceeding a threshold score verifying a person associated with the customer email is the existing customer, whereby security of the existing financial data of the existing customer's account is preserved during confirmation by presenting the existing financial data through the user interface responsive to verifying the identity of the person associated with the customer email address while excluding such existing financial data from the email;
instructions to receive one or more confirmation responses from user-interactions with the user interface in which a user agrees or disagrees with accuracy of the existing financial data of the existing customer's account retrieved from the data source, wherein the existing financial data retrieved by the server from the data source for confirmation predates any information entered through the user interface;
instructions to store the confirmation responses received through interaction with the user interface;
instructions to flag the account of the existing customer as needing to proceed with a physical confirmation process responsive to the score being less than the threshold score; and
instructions to generate a dashboard showing substantially real-time metrics regarding confirmation status of the plurality of accounts of the financial institution, wherein the dashboard presents metrics regarding at least completed items and total confirmations.

2. The accounts confirmation system of claim 1, wherein the email includes a unique pin number.

3. The accounts confirmation system of claim 2, wherein communication with the third-party ID verification server is responsive to entering an accurate pin number into a website associated with the network address linked in the email.

4. The accounts confirmation system of claim 1, wherein the existing financial data information presented through the user interface is one or more of account number, balance, interest rate, and/or current maturity date.

5. The accounts confirmation system of claim 1, wherein the user interface includes a portion from which a user can agree or disagree with accuracy of the existing financial data information.

6. The accounts confirmation system of claim 1, wherein the dashboard is configured to present metrics at least with regard to outstanding confirmations that are paper-based and electronic confirmations.

7. An accounts confirmation system for confirming accuracy of financial information in an account of a customer of a financial institution, the accounts confirmation system comprising:
a data source having stored thereon data regarding a plurality of accounts of a financial institution to be confirmed, wherein the data source regarding the plurality of accounts comprises existing financial data of an existing account of an existing customer of the financial institution;
a customer portal configured to provide a user interface accessible by a computing device over a network and configured to communicate with a third-party ID verification server through an application programing interface (API) of the third-party ID verification server;
a server in data communication with the data source and the customer portal, wherein the server includes a computer program embedded in a computer readable medium comprising computer executable instructions for execution by a processor, the computer program comprising:
instructions to determine a customer email address associated with the existing account of the existing customer to be confirmed from the plurality of accounts of the financial institution;
instructions to generate an email to the customer email address seeking confirmation of data regarding the existing account of the existing customer to be confirmed, wherein the email includes a link to a network address of the customer portal, but excludes any of the existing financial data of the existing customer's account from the email;
instructions to store confirmation responses received through customer interaction with the customer portal;
wherein the customer portal is configured to determine a score representing a confidence level with which the third-party ID verification server verified an identity of the person associated with the customer email is the existing customer by interacting with the third-party ID verification server;
wherein customer portal is configured to electronically confirm whether at least a portion of the existing financial data of the existing customer's account is accurate by user-interaction with the user interface, wherein the existing financial data regarding the existing customer's account retrieved from the data source is presented responsive to the score exceeding a threshold score, wherein the existing financial data retrieved by the server from the data source for confirmation predates any information entered through the user interface, whereby security of the existing financial data of the existing customer's account is preserved during confirmation by presenting the existing financial data through the user interface responsive to verifying the identity of the person associated with the customer email address while excluding such existing financial data from the email; and
wherein, responsive to the score being less than the threshold score, flagging the existing account of the existing customer as needing to proceed with a physical confirmation process.

8. The accounts confirmation system of claim 7, wherein the email includes a unique pin number.

9. The accounts confirmation system of claim 8, wherein communication with the third-party ID verification server is responsive to entering an accurate pin number into the customer portal.

10. The accounts confirmation system of claim 7, wherein the existing financial data presented through the user interface is one or more of account number, balance, interest rate, and/or current maturity date.

11. The accounts confirmation system of claim 7, wherein the user interface includes a portion from which a user can agree or disagree with accuracy of the existing financial data.

12. The accounts confirmation system of claim 7, further comprising instructions to generate a dashboard showing substantially real-time metrics regarding confirmation status of the plurality of accounts of the financial institution, wherein the dashboard presents metrics regarding at least completed items and total confirmations.

13. An apparatus comprising:
a storage device; and
at least one processor coupled to the storage device, wherein the storage device stores a program for controlling the at least one processor, and wherein the at least one processor, being operative with the program, is configured to:
obtain a population of data regarding a plurality of existing accounts of a financial institution;
generate a sample dataset from the population of data regarding the plurality of existing accounts of the financial institution;
receive a request to send account confirmations to a plurality of existing customers of the financial institution;
generating a plurality of confirmation requests, including a pin number associated with respective customers of the plurality of existing customers of the financial institution, wherein generating the plurality of confirmation requests comprises generating a plurality of emails to email addresses associated with respective customers of the plurality of existing customers of the financial institution, wherein the plurality of emails are configured to exclude existing financial data of the plurality of existing customers from the plurality of emails;
responsive to receiving a communication from a customer with the pin number, requesting verification of the customer by communicating with a third-party identification verification server through an application programing interface (API) of the third-party ID verification server;
determining a score representing a confidence level with which the third-party ID verification server verified the identity of a person associated with the customer email is the existing customer;
responsive to the score exceeding a threshold score from the third-party identification verification server, presenting at least a portion of the sample dataset regarding one or more existing accounts to the customer for confirmation;
receive one or more confirmation responses from user-interactions with the user interface in which a user agrees or disagrees with accuracy of the sample dataset presented on the interface of the existing customer's account retrieved from the sample dataset, wherein the existing financial data retrieved by the server from the sample dataset for confirmation predates any information entered through the user interface, whereby security of the existing financial data of the existing customer's account is preserved during confirmation by presenting the existing financial data through the user interface responsive to verifying the identity of the person associated with the customer email address while excluding such existing financial data from the email;
storing one or more confirmation responses received through the user interface; and
flagging the account of the existing customer as needing to proceed with a physical confirmation process responsive to the score being less than the threshold score.

14. The apparatus of claim 13, wherein the plurality of emails includes a link to a network address of the third-party ID verification server.

15. The apparatus of claim 13, wherein the user interface includes a portion from which a user can agree or disagree with accuracy of the existing financial data information.

16. The apparatus of claim 13, further comprising a dashboard configured to present metrics at least with regard to outstanding confirmations that are paper-based and electronic confirmations.
